(19) United States
(12) Patent Application Publication
(10) Pub. No.: US 2011/0200352 A1
(43) Pub. Date: Aug. 18, 2011

(54) IMAGE FORMING APPARATUS AND CLEANING METHOD OF CHARGING ROLLER

(75) Inventors: Daisuke Yamashita, Shizuoka-ken (JP); Takeshi Watanabe, Kanagawa-ken (JP)

(73) Assignees: KABUSHIKI KAISHA TOSHIBA, Tokyo (JP); TOSHIBA TEC KABUSHIKI KAISHA, Tokyo (JP)

(21) Appl. No.: 13/025,392

(22) Filed: Feb. 11, 2011

Related U.S. Application Data
(60) Provisional application No. 61/305,373, filed on Feb. 17, 2010.

(51) Int. Cl. G03G 15/02; G03G 21/00

(52) U.S. Cl. 399/100; 399/128

(57) ABSTRACT

An image forming apparatus includes a photoreceptor, a charging roller and a guide member. The guide member is disposed near an outer circumferential surface of the charging roller, and extends in an axial direction of the charging roller, a cleaning member for cleaning the charging roller is engaged with and disengaged from the guide member, and the guide member guides the cleaning member in the axial direction of the charging roller.

### CROSS-REFERENCE TO RELATED APPLICATION

This application is based upon and claims the benefit of priority from U.S. provisional application 61/305,373, filed on Feb. 17, 2010; the entire contents of which are incorporated herein by reference.

### FIELD

Embodiments described herein relate generally to a cleaning technique of a charging roller.

### BACKGROUND

Hitherto, as a system for uniformly charging a photoreceptor, a contact charging system and a non-contact charging system are known. A charging roller used in the contact charging system includes a metallic core metal and a conductive elastic layer disposed outside the core metal. In the contact charging system, a bias voltage is applied to the charging roller while the charging roller is brought into contact with a photoreceptor, and the photoreceptor is charged. A charging roller used in the non-contact charging system includes a metallic core metal, a conductive resin layer disposed outside the core metal, and a gap holding member disposed at both ends of the core metal and having an outer diameter slightly larger than the resin layer. The gap holding member contacts a photoreceptor, forms a small gap between the photoreceptor and the resin layer, and causes the charging roller to be brought into non-contact with the photoreceptor. In the non-contact charging system, a bias voltage is applied to the charging roller, and the charging roller charges the photoreceptor through the gap.

When the charging roller used in the contact charging system and the non-contact charging system is used for a long period, dirt such as toner, external additive agent and paper powder adheres to the surface of the charging roller. When the dirt adheres to the surface of the charging roller, discharge of the adhesion portion becomes insufficient, and defective charging of the charging roller occurs. Thus, when the dirt adheres to the surface of the charging roller of an image forming apparatus, a defect such as a streak appears on an image. Especially in the charging roller of the contact charging system, when the charging roller is continued to be used while the dirt adheres to the surface of the charging roller, durability of the charging roller is remarkably damaged due to the friction with the photoreceptor.

Hitherto, there is a case where a cleaning member such as a sponge roller or a brush roller is always brought into contact with a charging roller, and dirt adhered to the charging roller is cleaned.

However, in this cleaning method, since the cleaning member is always brought into contact with the charging roller, the charging roller and the cleaning member are worn, and there is a problem that the lives of the charging roller and the cleaning member are shortened. Besides, in the related art cleaning method, there is a fear that a defect called filming occurs in which dirt is fixed to the surface of the charging roller by the friction between the charging roller and the cleaning member.

As a method of solving this problem, it is conceivable that a separating mechanism to separate a cleaning member from a charging roller is provided, and the cleaning member is brought into contact with the charging roller only at the time of a cleaning operation by this separating mechanism. However, when the separating mechanism is provided, there is a problem that the design and manufacture become complicated and the cost is increased.

### BRIEF DESCRIPTION OF THE DRAWINGS

FIG. 1 is a perspective view showing an image forming apparatus.

FIG. 2 is a schematic structural view showing an image forming part.

FIG. 3 is a perspective view showing a guide rail and a cleaning member.

FIG. 4 is a flowchart showing an operation of the image forming apparatus.

FIG. 5 is a view showing a cleaning execution instruction receiving screen.

FIG. 6 is a view showing a cleaning end instruction receiving screen.

FIG. 7 is a perspective view showing a cleaning method of a charging roller by a cleaning member.

FIG. 8 is a schematic structural view showing an image forming part of a second embodiment.

FIG. 9 is a view showing a modified example of a guide member.

FIG. 10 is a view showing a modified example of a guide member.

### DETAILED DESCRIPTION

In general, according to an aspect of the invention, an image forming apparatus includes a photoreceptor, a charging roller and a guide member. The photoreceptor transfers a toner image to a transfer target member. The charging roller charges the photoreceptor. The guide member is disposed near an outer circumferential surface of the charging roller, and extends in an axial direction of the charging roller, a cleaning member for cleaning the charging roller is engaged with and disengaged from the guide member, and the guide member guides the cleaning member in the axial direction of the charging roller.

In general, according to another aspect of the invention, a cleaning method of a charging roller includes inserting a cleaning member into a guide member of an image forming apparatus including a photoreceptor, a charging roller and the guide member. The photoreceptor transfers a toner image to a transfer target member. The charging roller charges the photoreceptor. The guide member is disposed near an outer circumferential surface of the charging roller, and extends in an axial direction of the charging roller, a cleaning member for cleaning the charging roller is engaged with and disengaged from the guide member, and the guide member guides the cleaning member in the axial direction of the charging roller. Besides, in the cleaning method of the charging roller, the cleaning member is moved in the axial direction of the charging roller while being guided by the guide member, and the cleaning member cleans the charging roller.

### First Embodiment

Hereinafter, a first embodiment will be described with reference to the drawings.

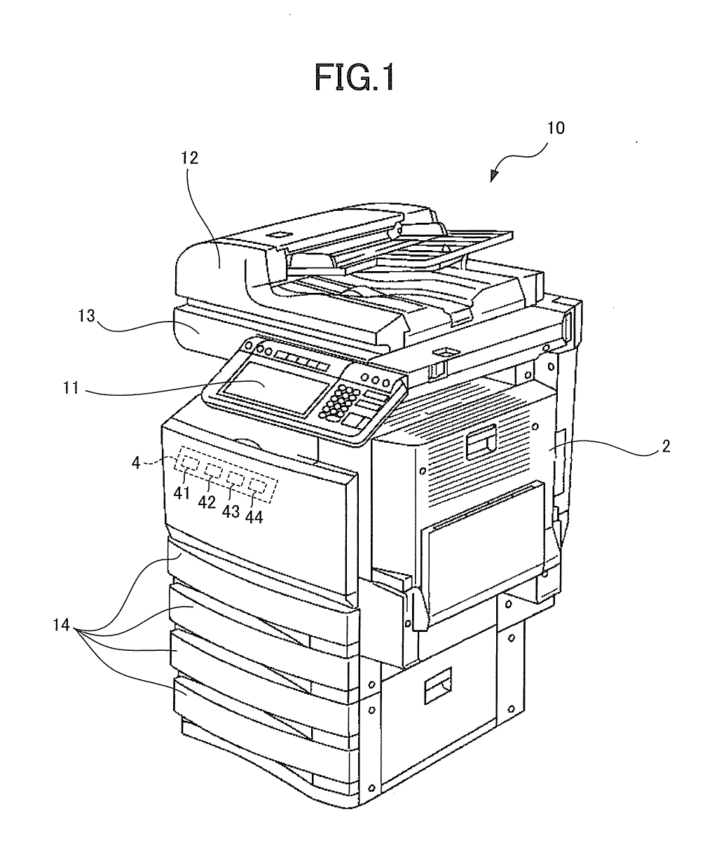

FIG. 1 is a perspective view showing an image forming apparatus 10.

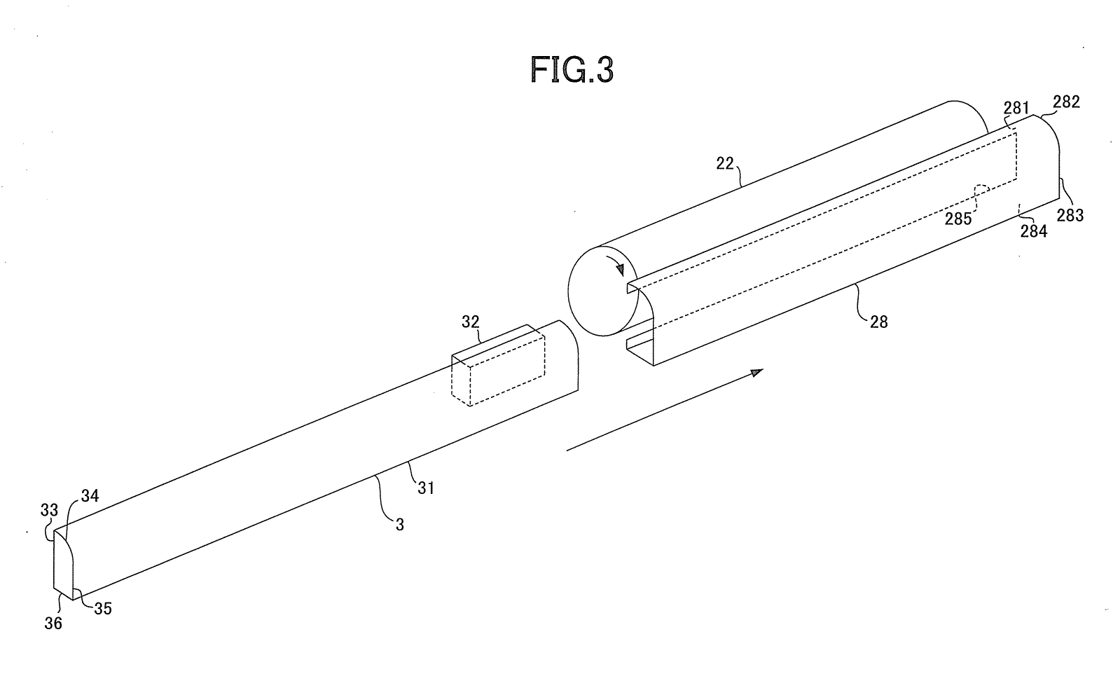

The image forming apparatus 10 is an MFP (Multi Function Peripheral). The image forming apparatus 10 includes a touch panel 11, an ADF 12 (Auto Document Feeder), an image read part 13, a paper feed cassette 14, an image forming part 2, a cleaning member 3 (FIG. 3) and a control part 4.

The touch panel 11 serves as both a display part and an operation input part. As the display part, an LCD (Liquid Crystal Display), an EL (Electronic Luminescence), a PDP (Plasma Display Panel) and a CRT (Cathode Ray Tube) may be used. As the operation input part, a keyboard and a mouse may be used.

The control part 4 controls the whole image forming apparatus 10. The control part 4 includes a processor 41, an ASIC 42 (Application Specific Integrated Circuit), a memory 43 and a HDD 44 (Hard Disk Drive). The processor 41 executes programs stored in the memory 43 and realizes various functions. The processor 41 may be a CPU (Central Processing Unit) or a MPU (Micro Processing Unit). The memory 43 may be a RAM (Random Access Memory), a ROM (Read Only Memory), a DRAM (Dynamic Random Access Memory), an SRAM (Static Random Access Memory) and a VRAM (Video RAM). The HDD 44 may be a flash memory. The ASIC 42 may perform a part of functions of the processor 41.

In the image forming apparatus 10, for example, by user's operation input to the touch panel 11, the image read part 13 reads a sheet set on the ADF 12 and generates image data. In the image forming apparatus 10, a sheet in the paper feed cassette 14 is sent to the image forming part 2, and the image forming part 2 forms the read image on the sheet based on the image data. Besides, the image forming apparatus 10 forms an image on a sheet based on image data transmitted from external devices.

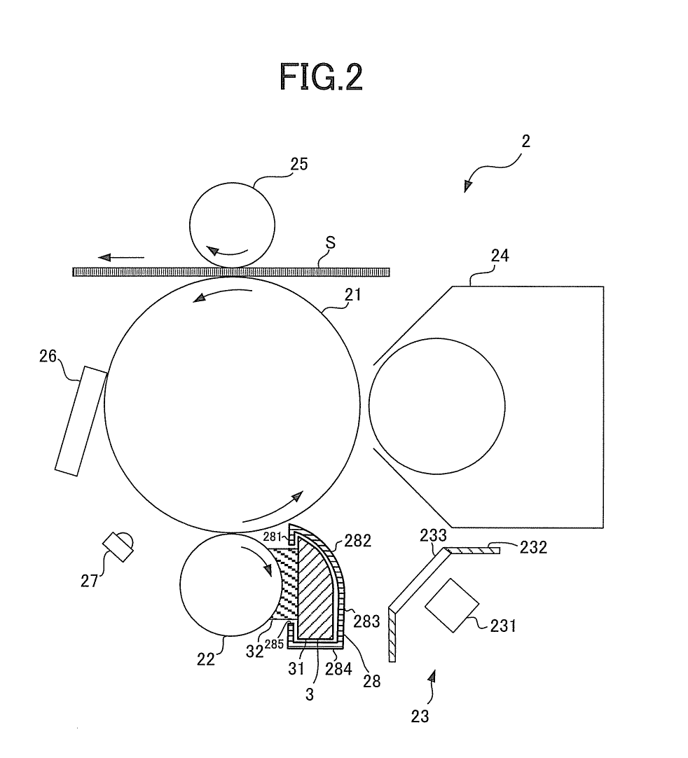

FIG. 2 is a schematic structural view showing the image forming part 2.

The image forming part 2 includes a photoreceptor 21, a charging roller 22, an exposure unit 23, a developing unit 24, a transfer member 25, a cleaning blade 26, an optical charge removing device 27 and a guide rail 28.

The charging roller 22 charges the photoreceptor 21. As the charging roller 22, a contact charging type one or a non-contact charging type one is used. In this embodiment, as the charging roller 22, the contact charging type one including a metallic core metal and a conductive elastic layer disposed outside the core metal is used. A bias voltage is applied to the charging roller 22. As the bias voltage, a direct current voltage or a voltage including an alternating current voltage superimposed on a direct current voltage is used. In this embodiment, as the bias voltage, the voltage including the alternating current voltage superimposed on the direct current voltage is used. The charging roller 22 discharges in the vicinity of a nip between itself and the photoreceptor 21, and uniformly charges the photoreceptor 21. When a negative polarity voltage is applied as the direct current voltage, the charging roller 22 negatively charges the photoreceptor 21. When a positive polarity voltage is applied as the direct current voltage, the charging roller positively charges the photoreceptor 21. In this embodiment, the negative polarity voltage is applied as the direct current voltage, and the charging roller 22 negatively charges the photoreceptor 21.

The charging roller 22 is controlled and rotated by the control part 4. When the charging roller 22 is pushed to the photoreceptor 21 and is rotated in accordance with the photoreceptor 21, and when the rotation of the photoreceptor 21 is transmitted to the charging roller 22 through a gear mechanism, the control part 4 rotates the photoreceptor 21, and causes the charging roller 22 to be rotated in accordance with the photoreceptor 21. When the charging roller 22 and the photoreceptor 21 are rotated by separate drive mechanisms, the control part 4 rotates and drives the charging roller 22 and the photoreceptor 21 separately.

The exposure unit 23 includes a light-emitting element 231, a polygon mirror, a lens and a housing 232.

The light-emitting element 231 is an element such as an LED (Light Emitting Diode) or an organic EL (Electro Luminescence), and emits laser light.

The polygon mirror rotates and reflects the laser light emitted from the light-emitting element 231. The light-emitting element 231 is lighted and controlled by the control part 4. The laser light emitted from the light-emitting element 231 is reflected by the polygon mirror and scans the photoreceptor 21, so that an electrostatic latent image is formed on the photoreceptor 21. On the photoreceptor 21, a minus electric charge is removed according to the intensity of the laser light in a part exposed to the laser light, and the minus potential becomes lower than that of the surroundings. On the photoconductive surface of the photoreceptor 21, the electrostatic latent image is formed from a portion where the minus potential is lower than that of the surroundings.

Plural lenses are provided, and correct to condense, diffuse, or collimate the laser light emitted from the light-emitting element 231.

The housing 232 contains therein optical parts so that dirt, such as toner, which causes defective exposure of the charging roller 22 does not adhere to the light-emitting element 231, the polygon mirror and the plural lenses, and the respective optical parts are positioned at specified positions. Apart of the housing 232 is a transparent light transmission part 233 made of cover glass or the like.

The light transmission part 233 is disposed in a periphery of the photoreceptor 21 and downstream of the charging roller 22 in the rotation direction of the photoreceptor 21 (counterclockwise direction in FIG. 2), and is opposite to the photoreceptor 21. The laser light emitted from the light-emitting element 231 passes through the light transmission part 233 and exposes the photoreceptor 21.

The developing unit 24 supplies a toner onto the photoreceptor 21, and reversely develops the electrostatic latent image on the photoreceptor 21. As the developing system of the electrostatic latent image by the developing unit 24, a one-component developing system using only a toner and a two-component developing system using a toner and a carrier are used. In this embodiment, the two-component developing system is used as the developing system of the electrostatic latent image by the developing unit 24. In the two-component developing system, the toner and the carrier are agitated, and the toner is friction charged. It is determined according to the material of the toner whether the toner is charged positively or negatively. In this embodiment, as the material of the toner, such a material is used that the toner is charged negatively. The developing unit 24 supplies a negative toner to a portion (electrostatic latent image) on the photoreceptor 21 having a minus potential lower than that of the surroundings, and forms a toner image on the photoreceptor.

The transfer member 25 is opposite to the photoreceptor 21 across a transfer target member S. As the transfer member 25, a roller made of conductive rubber or sponge, metal or the like, a conductive belt or sheet, a corona charger or the like is used. In this embodiment, as the transfer member 25, a roller made of metal is used. A positive bias voltage is applied to the transfer member 25. When the positive bias voltage is applied to the transfer member 25, a transfer electric field is formed between the transfer member 25 and the photoreceptor 21. The negatively charged toner image on the photoreceptor 21 is transferred onto the transfer target member S by this transfer electric field. When the transfer target member S is a sheet, a fixing process to heat and press the transfer target member S is performed to the transfer target member S, and the toner image is fixed to the transfer target member S. When the transfer target member S is a transfer roller or a transfer belt, after the toner image on the transfer target member S is transferred to a sheet through the transfer target member S, the fixing process is performed to the sheet, and the toner image is fixed to the sheet.

The cleaning blade 26 is made of rubber or the like, contacts the photoreceptor 21, and scrapes the residual toner on the photoreceptor 21. The scraped residual toner is sent to a toner discarding part by a toner feed mechanism. However, when the cleaning power of the cleaning blade 26 is reduced due to long term use or a condition such as environmental change, toner, external additive agent smaller than the toner and the like pass through the cleaning blade 26 and adhere to the charging roller 22 from the photoreceptor 21. Besides, toner, paper powder and the like floating in the image forming apparatus 10 also adhere to the charging roller 22 by electrostatic force or the like. Incidentally, the cleaning blade 26 may be a sponge roller or a brush roller.

As the optical charge removing device 27, for example, an LED can be used. The optical charge removing device 27 is disposed in a periphery of the photoreceptor 21 and upstream of the charging roller 22 in the rotation direction of the photoreceptor 21. The optical charge removing device 27 irradiates light to the photoreceptor 21, and removes the negative charge remaining on the photoreceptor 21.

The guide rail 28 guides the cleaning member 3 for cleaning the charging roller 22 in the axial direction of the charging roller 22. The guide rail 28 is disposed near the outer peripheral surface of the charging roller 22, and is disposed in a periphery of the photoreceptor 21, downstream of the charging roller 22 in the rotation direction of the photoreceptor 21 and upstream of the light transmission part 233 in the rotation direction of the photoreceptor 21.

FIG. 3 is a perspective view showing the guide rail 28 and the cleaning member 3.

The guide rail 28 is a tubular guide member extending in the axial direction of the charging roller 22. The guide rail 28 includes a flat first side surface 281 opposite to the charging roller 22, a curved second side surface 282 which is continuous with the side of the first side surface 281 close to the photoreceptor 21 and expands outward when viewed in section (when viewed in section perpendicular to the axial direction of the guide rail 28), a third side surface 283 which is continuous with the side of the second side surface far from the photoreceptor 21 and is parallel to the first side surface 281, and a fourth side surface 284 connected vertically to the first and the third side surfaces 281 and 283. The first side surface 281 includes a first opening 285 extending in the axial direction of the charging roller 22. The first opening 285 is longer than the charging roller 22 in the axial direction of the charging roller 22.

Incidentally, not only when the image forming part 2 is a four-cycle system in which the one photoreceptor 21 is provided, but also when the image forming part is a tandem system (for example, four-drum tandem system) having plural photoreceptors 21, the guide rail 28 is disposed near the outer peripheral surface of each of the charging rollers 22, and is disposed in a periphery of each of the photoreceptors 21 and between the optical charge removing device 27 and the light transmission part 233 in the rotation direction of the photoreceptor 21.

The cleaning member 3 has a longitudinal shape, and includes a support body 31 and a first cleaning part 32. The cleaning member 3 is engaged with and disengaged from the guide rail 28. In this embodiment, the cleaning member 3 is inserted in the guide rail 28 so that it is engaged with the guide rail 28, and is pulled out from the guide rail 28 so that the engagement with the guide rail 28 is released. The cleaning member 3 is inserted in the guide rail 28, and moves back and forth along the guide rail 28, so that the first cleaning part 32 cleans the charging roller 22. The cleaning member 3 is disposed detachably from the image forming apparatus 10 at the back of a cover of the image forming apparatus 10 or the side of the image forming apparatus 10.

The support body 31 includes a flat first surface 33 which is opposite to the first side surface 281 and to which the first cleaning part 32 is fixed, a curved second surface 34 which expands outward when viewed in section (when viewed in section perpendicular to the axial direction of the support body 31) and is opposite to the second side surface 282, a third surface 35 which is parallel to the first surface 33 and is opposite to the third side surface 283, and a fourth surface 36 connected vertically to the first and the third surfaces 283 and 285.

It is preferable that the first cleaning part 32 is a sponge or a brush capable of accumulating the dirt of the charging roller 22. At the time of cleaning of the charging roller 22 by the first cleaning part 32, when static electricity is generated by friction between the first cleaning part 32 and the charging roller 22, dirt such as floating toner and paper powder adheres to the charging roller 22. Accordingly, it is preferable that the material of the first cleaning part 32 is a conductive urethane foam, a conductive chloroprene rubber sponge or a conductive polyethylene foam, which has a volume resistivity of 10⁵ to 10¹¹ Ωcm.

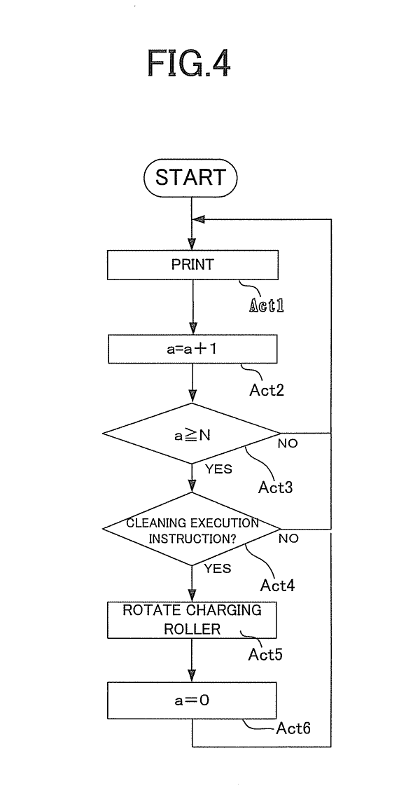

Hereinafter, the operation of the image forming apparatus 10 relating to the cleaning of the charging roller 22 will be described with reference to a flowchart of FIG. 4.

The control part 4 is first in a print mode in which a print operation can be performed. For example, when a user performs an operation input to the touch panel 11, the control part 4 controls so that a sheet set on the ADF 12 is read to generate image data, and the image forming part 2 forms an image on a sheet based on the image data (Act 1).

After Act 1, the control part 4 counts the number of image output sheets, and increments the count value “a” by one. The control part 4 causes the memory 43 to store the count value “a” (Act 2). The way of counting the number of image output sheets is arbitrary. For example, the control part 4 may count the number of image output sheets each time a signal for forming an image on one sheet is outputted to the image forming part 2. A paper discharge sensor to detect the leading edge or trailing edge of a sheet is provided downstream of a place where a fixing process such as heating and pressing is performed to a sheet in a sheet conveyance path. The control part 4 may count the number of image output sheets based on the detection signal from the paper discharge sensor.

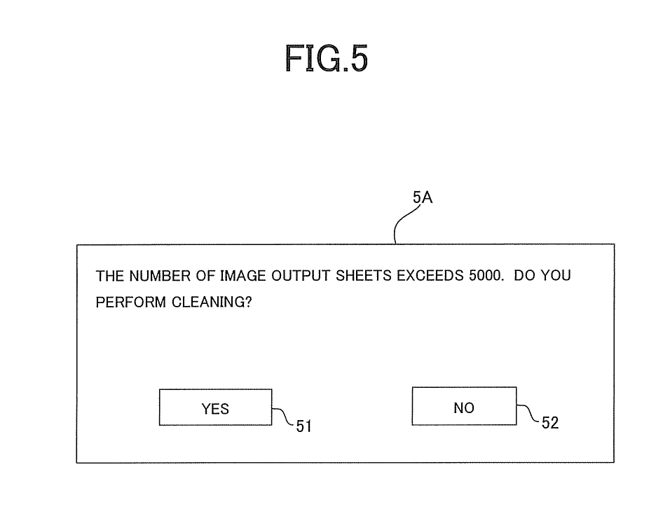

After Act 2, the control part 4 determines whether the count value “a” of the number of image output sheets is larger than a threshold N (for example, 5000) (Act 3). When the count value “a” of the number of image output sheets is larger than the threshold N (Act 13: YES), the control part 4 displays an execution instruction receiving screen 5A (FIG. 5) capable of receiving a cleaning execution instruction on the touch panel 11 (Act 4). The execution instruction receiving screen 5A includes an execution instruction button 51 and an execution non-instruction button 52.

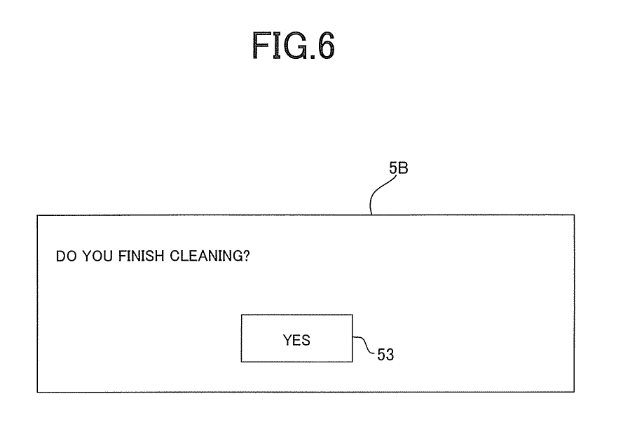

After Act 4, when the control part 4 receives the cleaning execution instruction by user's touch on the execution instruction button 51 or the like (Act 4: YES), the printable print mode is changed to an unprintable cleaning mode. The control part 4 rotates the charging roller 22, and displays an end instruction receiving screen 5B (FIG. 6) capable of receiving a cleaning end instruction on the touch panel 11 (Act 5). The end instruction receiving screen 5B includes an end instruction button 53. Incidentally, when the charging roller 22 is constructed to be rotated in accordance with the photoreceptor 21, the control part 4 rotates the photoreceptor 21, so that the charging roller 22 is rotated in accordance with the photoreceptor 21. Besides, when the charging roller 22 and the photoreceptor 21 are constructed to be rotated by separate drive mechanisms, the control part 4 rotates the charging roller 22 and the photoreceptor 21 separately.

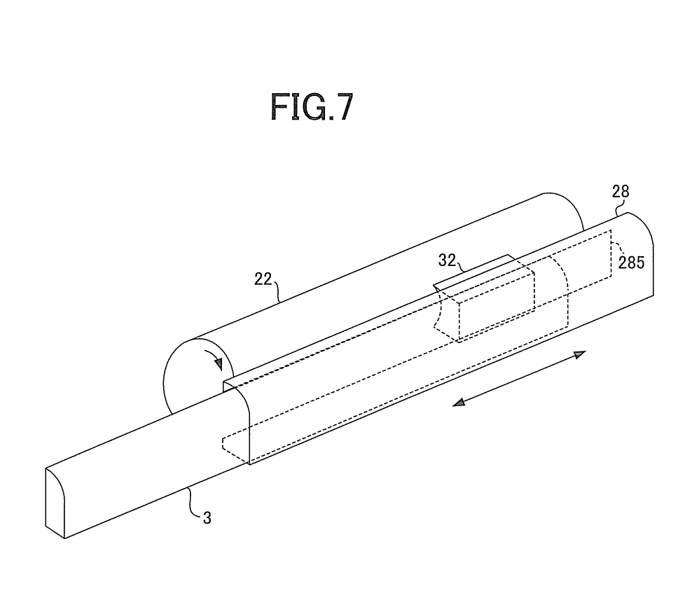

At Act 5 in the state where the control part 4 rotates the charging roller 22, the user inserts the cleaning member 3 into the guide rail 28, and moves the cleaning member 3 back and forth in the axial direction of the charging roller 22 while the cleaning member 3 is guided by the guide rail 28 (FIG. 7). The user removes toner, external additive agent, paper powder and the like adhered to the charging roller 22 by the first cleaning part 32, and cleans the whole surface of the charging roller 22. The control part 4 receives the cleaning end instruction when, for example, the user touches the end instruction button 53 after the cleaning of the charging roller 22 is ended. The control part 4 resets the count value “a” of the number of image output sheets to zero and ends the cleaning mode, and the mode returns to the printable print mode (Act 6).

When the count value “a” of the number of image output sheets is smaller than the threshold N (Act 3: NO) or the control parts 4 receives the cleaning non-execution instruction by the user's touch on the execution non-instruction button 52 or the like (Act 4: NO), returns is made to Act 1.

Incidentally, an insertion detection sensor to detect whether the cleaning member 3 is inserted in the guide rail 28 may be provided. In this case, even if the cleaning execution instruction is received (Act 4; YES), the control part 4 does not display the end instruction receiving screen 5B. After Act 4, when the insertion detection sensor inputs a signal indicating that the cleaning member 3 is inserted in the guide rail 28, the control part 4 rotates the charging roller 22 (Act 5). At Act 5, when the user cleans the charging roller 22 by the cleaning member 3 and pulls out the cleaning member 3 from the guide rail 28, the insertion detection sensor inputs a signal (cleaning end signal) indicating that the cleaning member 3 is not inserted in the guide rail 28 to the control part 4. The control part 4 resets the count value “a” of the number of image output sheets to zero and ends the cleaning mode, and the mode returns to the printable print mode (Act 6).

### Second Embodiment

Hereinafter, the same function part as that of the foregoing embodiment is denoted by the same reference numeral and its explanation is omitted.

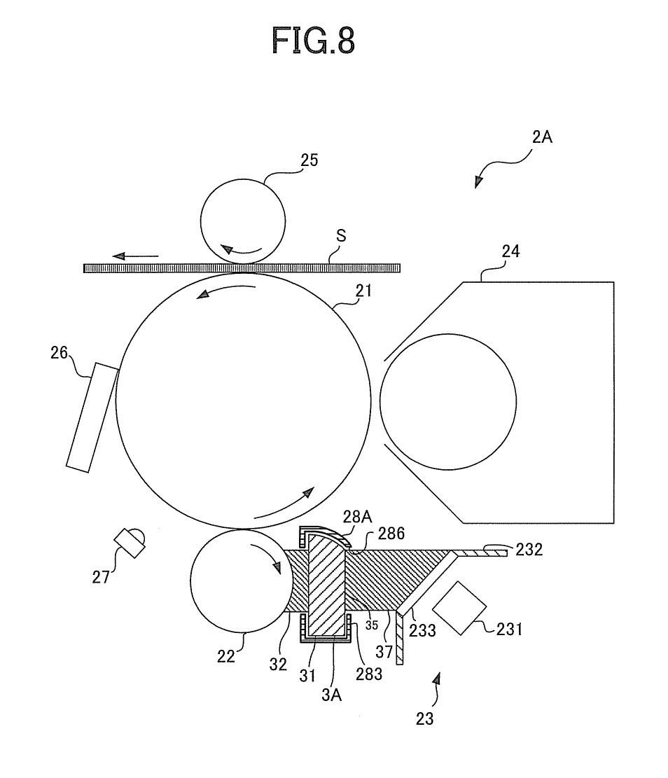

FIG. 8 is a schematic structural view showing an image forming part 2A.

In this embodiment, a third side surface 283 of a guide rail 28A opposite to a light transmission part 233 has a second opening 286 extending in an axial direction of a charging roller 22. A second cleaning part 37 is fixed to a third surface 35 of a cleaning member 3A opposite to the third side surface 283. When the cleaning member 3A is inserted in the guide rail 28A, the second cleaning part 37 contacts the light transmission part 233. The second cleaning part 37 is preferably a sponge or a brush. It is preferable that the material of the second cleaning part 37 is a conductive urethane foam, a conductive chloroprene rubber sponge, or a conductive polyethylene foam, which has such conductivity that static electricity is not generated.

In this embodiment, the user performs an operation input to the touch panel 11 to rotate the charging roller 22, and inserts the cleaning member 3A into the guide rail 28A in this state. In the state where the charging roller 22 is rotated, the user moves the cleaning member 3A back and forth along the guide rail 28A, and cleans the whole surface of the charging roller 22 and the light transmission part 233 at once. The other structure of this embodiment is the same as the foregoing embodiment.

In the first and the second embodiments, it is not necessary to cause the cleaning member 3, 3A to always contact the charging roller 22, the abrasion of the charging roller 22 and the cleaning member 3, 3A can be reduced, and the occurrence of filming can be prevented. Besides, in the first and the second embodiments, the reduction of the abrasion of the charging roller 22 and the cleaning member 3, 3A and the prevention of the occurrence of the filming can be realized by the simple structure. Especially, when the image forming apparatus 10 is a tandem system, as compared with the structure in which a complicated separating mechanism is provided for each of the charging rollers 22, in the first and the second embodiments, the guide rail 28 is merely provided in the vicinity of the outer peripheral surface of each of the charging rollers 22. Thus, the structure of the image forming apparatus 10 can be greatly simplified, and the cost can be reduced.

In the first and the second embodiments, the sectional shapes of the guide rail 28, 28A and the support body 31 of the cleaning member 3, 3A are substantially rectangular, and in the corners near the photoreceptor 21, the corner at the side far from the charging roller 22 has the curved shape expanding outward when viewed in section. Thus, even if toner drops from the photoreceptor 21 to the guide rail 28, 28A, the toner drops from the guide rail 28, 28A and is discharged to the outside of the image forming apparatus 10. Besides, the sectional shapes of the guide rail 28, 28A and the support body 31 of the cleaning member 3, 3A are similar and horizontally asymmetrical to each other when viewed in section. Thus, it is possible to prevent that the cleaning member 3, 3A is inserted in the guide rail 28, 28A in the state where its direction is erroneous, and the damage of the guide rail 28, 28A and the cleaning member 3, 3A can be prevented.

In the first and the second embodiments, the guide rail 28, 28A is disposed in a periphery of the photoreceptor 21, downstream of the charging roller 22 in the rotation direction of the photoreceptor 21 and upstream of the exposure unit 23 in the rotation direction of the photoreceptor 21. Thus, it is possible to prevent that the guide rail 28, 28A blocks the light irradiated from the optical charge removing device 27.

When the guide rail 28, 28A is located at the position opposite to the photoreceptor 21 across the charging roller 22, toner is liable to drop to the guide rail 28, 28A from the charging roller 22, and there is a fear that the toner is stored in the guide rail 28, 28A. Besides, the image forming part 2 becomes large by the provision of the guide rail 28, 28A. On the other hand, in the first and the second embodiments, the guide rail 28, 28A is positioned at the side of the charging roller 22 and in the direction perpendicular to the line connecting the center of the guide rail 28, 28A and the charging roller 22. Thus, it is possible to prevent that toner drops from the charging roller 22 to the guide rail 28, 28A. Besides, since the guide rail 28, 28A is disposed in the dead space between the charging roller 22 and the light transmission part 233, it is not necessary to enlarge the image forming part 2.

In the first and the second embodiments, since the guide rail 28, 28A has the tubular shape to cover the support 31 of the cleaning member 3, 3A, it is possible to prevent that toner which drops from the photoreceptor 21 or toner which is removed from the charging roller 22 and floats adheres to the support 31 of the cleaning member 3, 3A.

### Modified Example

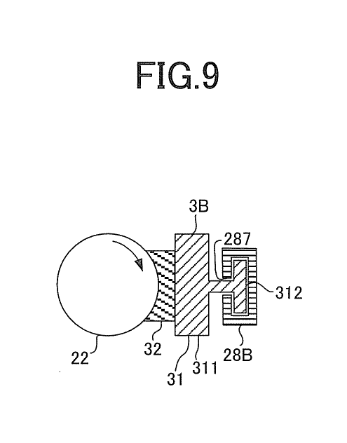

As long as a cleaning member is engaged with and disengaged from a guide member and the cleaning member can be guided in an axial direction of a charging roller, the shape of the guide member is arbitrary. As shown in FIG. 9, for example, a guide member 28B has a tubular shape and extends in an axial direction of a charging roller 22, and a groove 287 extending in the axial direction of the charging roller 22 may be provided on an outer peripheral surface. A support body 31 of a cleaning member 3 may include a longitudinal main body 311 to which a first cleaning part 32 is fixed and which extends in a direction vertical to the paper surface in FIG. 9, and an insertion and disinsertion part 312 which is connected to the main body 311, has a longitudinal shape extending in the direction vertical to the paper surface in FIG. 9, has a T shape, and is inserted in and disinserted from the guide member 28B.

Besides, also when the guide member has the tubular shape to cover the cleaning member, the shape may not be the complete tubular shape. For example, the fourth side surface 284 (FIG. 2) as the lower surface may not be provided. As long as the cleaning member is engaged with and disengaged from the guide member, the shape may be arbitrary.

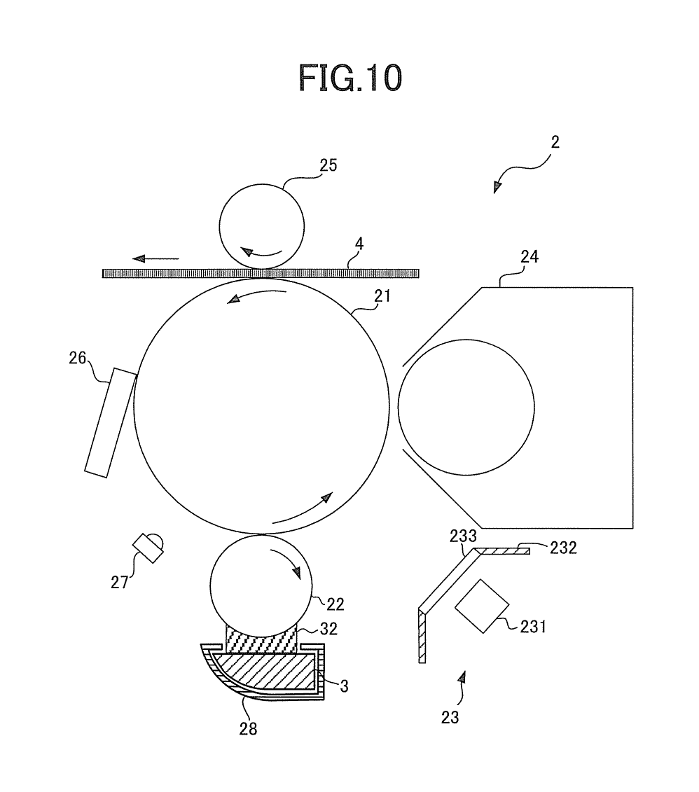

The guide member may not be disposed in a periphery of the photoreceptor and between the charging roller and the light transmission part of the exposure unit in the rotation direction of the photoreceptor. The guide member has only to be disposed near the outer peripheral surface of the charging roller. As shown in FIG. 10, a guide member 28 may be disposed at a position close to the outer peripheral surface of a charging roller 22 and at the position opposite to a photoreceptor 21 across the charging roller 22.

As a recording medium, any form may be used as long as the storage medium can store a program and can be read by a computer. Specifically, as the recording medium, for example, an internal storage device mounted in the inside of a computer, such as a ROM or a RAM, a portable storage medium such as a CD-ROM, a flexible disk, a DVD disk, a magneto-optical disk, or an IC card, a database to store computer programs, or another computer and its database can be enumerated. The function obtained by installation or download may realize the function in cooperation with the OS in the inside of the apparatus. Incidentally, part or the whole of a program may be a dynamically generated execution module.

The sequence of the respective processes in the embodiment may be different from the sequence exemplified in the embodiment.

As described above in detail, according to the technique disclosed in the specification, the cleaning technique of the charging roller can be provided.

While certain embodiments have been described, these embodiments have been presented by way of example only, and are not intended to limit the scope of invention. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus comprising:
a photoreceptor to transfer a toner image to a transfer target member;
a charging roller to charge the photoreceptor; and
a guide member which is disposed near an outer circumferential surface of the charging roller and extends in an axial direction of the charging roller, with and from which a cleaning member for cleaning the charging roller is engaged and disengaged, and which guides the cleaning member in the axial direction of the charging roller.

2. The apparatus of claim 1, further comprising:
an optical charge removing device which irradiates light to the photoreceptor to remove electricity from the photoreceptor and is disposed in a periphery of the photoreceptor and upstream of the charging roller in a rotation direction of the photoreceptor; and
an exposure unit which exposes the photoreceptor and is disposed downstream of the charging roller in the rotation direction of the photoreceptor, wherein
the guide member is disposed downstream of the charging roller in the rotation direction of the photoreceptor and upstream of the exposure unit in the rotation direction of the photoreceptor.

3. The apparatus of claim 1, wherein
the cleaning member includes a support body which is engaged with the guide member, and a first cleaning part which is fixed to the support body, contacts the charging roller, and is a sponge to clean the charging roller.

4. The apparatus of claim 1, wherein
the cleaning member includes a support body which is engaged with the guide member, and a first cleaning part which is fixed to the support body, contacts the charging roller, and is a brush to clean the charging roller.

5. The apparatus of claim 1, wherein
the guide member has a tubular shape and includes an outer peripheral surface having a first opening extending in the axial direction of the charging roller, and
the cleaning member includes a support body which is inserted in the guide member, and a first cleaning part which is fixed to the support body, contacts the charging roller through the first opening, and cleans the charging roller.

6. The apparatus of claim 5, wherein
the guide member includes a flat first side surface opposite to the charging roller and having the first opening, a curved second side surface which is continuous with a side of the first side surface close to the photoreceptor and expands outward when viewed in section, and a third side surface which is continuous with a side of the second side surface far from the photoreceptor and is parallel to the first side surface, and
the support body includes a flat first surface which is opposite to the first side surface and to which the first cleaning part is fixed, a second surface which has a curved shape expanding outward when viewed in section and is opposite to the second side surface, and a third surface which is parallel to the first surface and is opposite to the third side surface.

7. The apparatus of claim 1, further comprising an exposure unit which emits light to the photoreceptor through a light transmission part and exposes the photoreceptor, wherein
the light transmission part is disposed in a periphery of the photoreceptor and downstream of the charging roller in a rotation direction of the photoreceptor, and is opposite to the photoreceptor, and
the guide member is disposed in a periphery of the photoreceptor, downstream of the charging roller in the rotation direction of the photoreceptor and upstream of the light transmission part in the rotation direction of the photoreceptor, and guides the cleaning member to clean both the charging roller and the light transmission part in the axial direction of the charging roller.

8. The apparatus of claim 7, wherein
the cleaning member includes a support body which is engaged with the guide member, a first cleaning part which is fixed to the support body and contacts the charging roller to clean the charging roller, and a second cleaning part which is fixed to the support body, and contacts the light transmission part to clean the light transmission part, and
at least one of the first and the second cleaning parts is a sponge.

9. The apparatus of claim 7, wherein
the cleaning member includes a support body which is engaged with the guide member, a first cleaning part which is fixed to the support body and contacts the charging roller to clean the charging roller, and a second cleaning part which is fixed to the support body, and contacts the light transmission part to clean the light transmission part, and
at least one of the first and the second cleaning parts is a brush.

10. The apparatus of claim 7, wherein
the guide member has a tubular shape and includes an outer peripheral surface having a first opening and a second opening extending in the axial direction of the charging roller, and
the cleaning member includes a support body which is inserted in the guide member, a first cleaning part which is fixed to the support body, contacts the charging roller through the first opening, and cleans the charging roller, and a second cleaning part which is fixed to the support body, contacts the light transmission part through the second opening, and cleans the light transmission part.

11. The apparatus of claim 1, further comprising:
an operation input part; and
a control part to rotate the charging roller when a user performs an operation input to the operation input part to clean the charging roller by the cleaning member.

12. A cleaning method of a charging roller, comprising:
inserting a cleaning member into a guide member of an image forming apparatus including a photoreceptor to transfer a toner image to a transfer target member, a charging roller to charge the photoreceptor, and the guide member which is disposed near an outer circumferential surface of the charging roller, and extends in an axial direction of the charging roller, with and from which the cleaning member for cleaning the charging roller is engaged and disengaged, and which guides the cleaning member in the axial direction of the charging roller; and
cleaning the charging roller by the cleaning member by moving the cleaning member in the axial direction of the charging roller while the guide member guides the cleaning member.

13. The method of claim 12, wherein
an optical charge removing device which irradiates light to the photoreceptor to remove electricity from the photoreceptor is disposed in a periphery of the photoreceptor and upstream of the charging roller in a rotation direction of the photoreceptor, an exposure unit which exposes the photoreceptor is disposed downstream of the charging roller in the rotation direction of the photoreceptor, and the guide member is disposed downstream of the charging roller in the rotation direction of the photoreceptor and upstream of the exposure unit in the rotation direction of the photoreceptor.

14. The method of claim 12, wherein
the cleaning member includes a support body which is engaged with the guide member, and a first cleaning part which is fixed to the support body, contacts the charging roller, and is a sponge to clean the charging roller.

15. The method of claim 12, wherein
the cleaning member includes a support body which is engaged with the guide member, and a first cleaning part which is fixed to the support body, contacts the charging roller, and is a brush to clean the charging roller.

16. The method of claim 12, wherein
the guide member has a tubular shape, and includes an outer peripheral surface having a first opening extending in the axial direction of the charging roller, and
the cleaning member includes a support body which is inserted in the guide member, and a first cleaning part which is fixed to the support body, contacts the charging roller through the first opening, and cleans the charging roller.

17. The method of claim 12, wherein
the guide member includes a flat first side surface opposite to the charging roller and having a first opening, a curved second side surface which is continuous with a side of the first side surface close to the photoreceptor and expands outward when viewed in section, and a third side surface which is continuous with a side of the second side surface far from the photoreceptor and is parallel to the first side surface, and
the support body includes a flat first surface which is opposite to the first side surface and to which the first cleaning part is fixed, a second surface which has a curved shape expanding outward when viewed in section and is opposite to the second side surface, and a third surface which is parallel to the first surface and is opposite to the third side surface.

18. The method of claim 12, wherein
an exposure unit which emits light to the photoreceptor through a light transmission part and exposes the photoreceptor is provided,
the light transmission part is disposed in a periphery of the photoreceptor and downstream of the charging roller in a rotation direction of the photoreceptor, and is opposite to the photoreceptor, and
the guide member is disposed in a periphery of the photoreceptor, downstream of the charging roller in the rotation direction of the photoreceptor and upstream of the light transmission part in the rotation direction of the photoreceptor, and guides the cleaning member to clean both the charging roller and the light transmission part in the axial direction of the charging roller.

19. The method of claim 12, wherein
the guide member has a tubular shape and includes an outer peripheral surface having a first opening and a second opening extending in the axial direction of the charging roller, and
the cleaning member includes a support body which is inserted in the guide member, a first cleaning part which is fixed to the support body, contacts the charging roller through the first opening and cleans the charging roller, and a second cleaning part which is fixed to the support body, contacts the light transmission part through the second opening and cleans the light transmission part.

20. The method of claim 12, wherein
the charging roller is rotated when a user performs an operation input to an operation input part to clean the charging roller by the cleaning member.
